(19) United States
(12) Patent Application Publication
(10) Pub. No.: US 2025/0184466 A1
(43) Pub. Date: Jun. 5, 2025

(54) DISPLAY CONTROLLING APPARATUS, DISPLAY CONTROLLING METHOD, AND STORAGE MEDIUM

(71) Applicant: CANON KABUSHIKI KAISHA, Tokyo (JP)

(72) Inventor: DAICHI ADACHI, Tokyo (JP)

(21) Appl. No.: 18/965,757

(22) Filed: Dec. 2, 2024

(30) Foreign Application Priority Data
Dec. 4, 2023 (JP) 2023-204963

(51) Int. Cl. H04N 13/279; G06T 7/62; G06T 15/20

(52) U.S. Cl. CPC H04N 13/279; G06T 7/62; G06T 15/20

(57) ABSTRACT

A display controlling apparatus determines a size of an object indicating an observed point in a case where a distance from a position of a first virtual viewpoint to a position of the observed point is a second distance longer than a first distance, to be larger than a size of the object indicating the observed point in a case where the distance from the position of the first virtual viewpoint to the position of the observed point is the first distance, and performs control of displaying a second virtual viewpoint image corresponding to a second virtual viewpoint different from the first virtual viewpoint, a distance from the position of the first virtual viewpoint to a position of the second virtual viewpoint being a predetermined distance, the second virtual viewpoint image including the object indicating the observed point having a determined size, and an object indicating the first virtual viewpoint.

### BACKGROUND

### Field

The present disclosure relates to a display controlling apparatus, a display controlling method, and a storage medium.

### Description of the Related Art

In recent years, a technique of performing synchronous image capturing by installing a plurality of physical cameras at different positions, and generating, using a plurality of images obtained by the image capturing, a virtual viewpoint image assumed to be captured from a virtual camera viewpoint. Japanese Patent Application Laid-Open No. 2014-215828 discusses a technique of generating a virtual viewpoint image using images of a subject captured with a plurality of cameras arranged in such a manner as to surround the subject.

Japanese Patent Application Laid-Open No. 2014-215828 also discusses that the position of a virtual camera and the position of an observed point indicating a point viewed from a virtual camera are designated by a user.

### SUMMARY

A display controlling apparatus according to an aspect of the present disclosure includes an acquisition unit configured to acquire information indicating a position of a first virtual viewpoint corresponding to a first virtual viewpoint image generated based on a plurality of captured images obtained by a plurality of imaging apparatuses, and information indicating a position of an observed point corresponding to the first virtual viewpoint, a determination unit configured to determine a size of an object indicating the observed point in a case where a distance from the position of the first virtual viewpoint to the position of the observed point is a second distance longer than a first distance, to be larger than a size of an object indicating the observed point in a case where the distance from the position of the first virtual viewpoint to the position of the observed point is the first distance, and a display control unit configured to perform control of displaying a second virtual viewpoint image corresponding to a second virtual viewpoint different from the first virtual viewpoint, a distance from the position of the first virtual viewpoint to a position of the second virtual viewpoint being a predetermined distance, the second virtual viewpoint image including the object indicating the observed point that has a determined size, and an object indicating the first virtual viewpoint.

Further features of the present disclosure will become apparent from the following description of exemplary embodiments with reference to the attached drawings.

### BRIEF DESCRIPTION OF THE DRAWINGS

FIG. 1 illustrates a configuration example of an image processing system according to one or more aspects of the present disclosure.

FIG. 2 illustrates an installation example of an imaging apparatus according to one or more aspects of the present disclosure.

FIG. 3 illustrates a hardware configuration according to one or more aspects of the present disclosure.

FIG. 4 illustrates a functional configuration of a display controlling apparatus according to one or more aspects of the present disclosure.

FIGS. 5A and 5B illustrate an example in which a second virtual viewpoint image is displayed on a display unit according to one or more aspects of the present disclosure.

FIG. 6 is a flowchart illustrating an operation of the display controlling apparatus according to one or more aspects of the present disclosure.

FIG. 7 illustrates a graph indicating a relationship between a distance to an observed point from a first virtual viewpoint controlled by the display controlling apparatus according to one or more aspects of the present disclosure, and an observed point object size coefficient.

FIG. 8 illustrates a functional configuration of a display controlling apparatus according to one or more aspects of the present disclosure.

FIG. 9 is a flowchart illustrating an operation of the display controlling apparatus according to one or more aspects of the present disclosure.

FIG. 10 illustrates a functional configuration of a display controlling apparatus according to one or more aspects of the present disclosure.

FIG. 11 illustrates a functional configuration of a display controlling apparatus according to one or more aspects of the present disclosure.

FIGS. 12A to 12C each illustrate a display example of a guide object according to one or more aspects of the present disclosure.

FIG. 13 illustrates a functional configuration of a display controlling apparatus according to one or more aspects of the present disclosure.

### DESCRIPTION OF THE EMBODIMENTS

In Japanese Patent Application Laid-Open No. 2014-215828, there has been an issue that it is difficult for a user to intuitively recognize the position of an observed point on a virtual space.

Thus, in view of the above-described issue, the present disclosure is directed to providing a technique of facilitating user's recognition of the position of an observed point of a virtual viewpoint on a virtual space.

Hereinafter, exemplary embodiments of the present disclosure will be described with reference to the drawings. The components to be described in the following exemplary embodiments each merely indicate an example of the exemplary embodiment, and are not intended to limit the present disclosure to these.

A virtual viewpoint image refers to an image to be generated by a user and/or an exclusive operator freely operating the position and the orientation of a virtual camera, and is also called a free viewpoint image or an arbitrary viewpoint image. In the present disclosure, while the description will be mainly given of a case where the designation of a virtual viewpoint is performed by a user operation, the designation of a virtual viewpoint may be automatically performed based on the result of image analysis. Unless otherwise stated, the description will be given assuming that the word “image” includes the concepts of both moving images and still images.

A virtual camera refers to an imaginary camera different from a plurality of imaging apparatuses actually installed around an imaging region, and is a concept used to conveniently describe a virtual viewpoint for the generation of a virtual viewpoint image. That is, the virtual viewpoint image can be regarded as an image captured from a virtual viewpoint set in a virtual space associated with an imaging region. Then, the position and orientation of a viewpoint in the virtual image capturing can be represented as the position and orientation of a virtual camera. In other words, the virtual viewpoint image can be said to be an image that simulates an image captured by a camera assumed to exist at the position of a virtual viewpoint set in a space. In the present exemplary embodiment, a temporal transition of a virtual viewpoint will be described as a virtual camera path. Nevertheless, the concept of the virtual camera need not be always used to implement the configuration of the present exemplary embodiment. That is, it is sufficient that information indicating a specific position in a space and information indicating orientation are at least set, and a virtual viewpoint image is generated in accordance with the set information.

The imaging apparatus is only required to include a physical camera. The imaging apparatus may also include a function of performing various types of image processing aside from the physical camera. For example, the imaging apparatus may include a processing unit that performs foreground-background separation processing. The imaging apparatus may also include a control unit that performs transmission control of transmitting images of a part of regions among captured images. The imaging apparatus may also include a plurality of physical cameras.

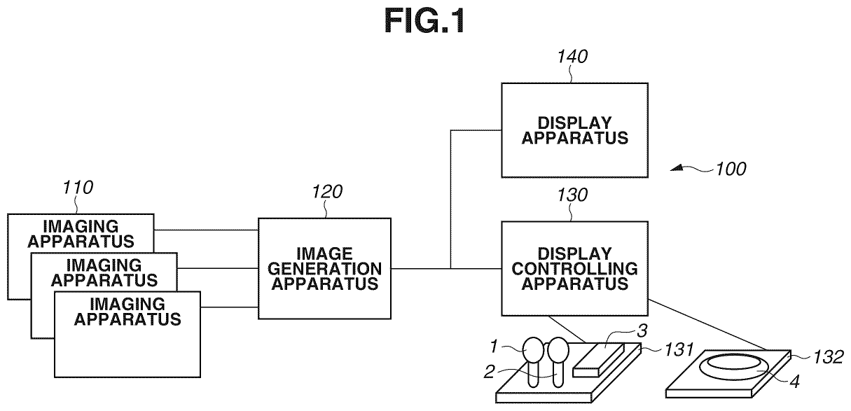

FIG. 1 is a diagram illustrating an image processing system 100 according to the present exemplary embodiment. The image processing system 100 includes a plurality of imaging apparatuses 110, an image generation apparatus 120, a display controlling apparatus 130, and a display apparatus 140. The imaging apparatuses 110, the image generation apparatus 120, and the display controlling apparatus 130 are connected via a communication cable such as a local area network (LAN) cable. In the present exemplary embodiment, the communication cable is assumed to be a LAN cable, but the communication cable is not limited to that in the exemplary embodiment. In addition, the image generation apparatus 120 and the display apparatus 140 are connected via a video signal transmission cable.

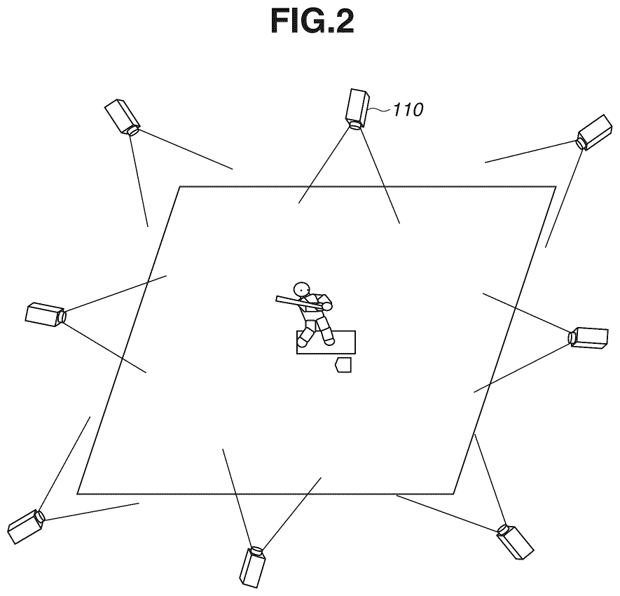

The imaging apparatus 110 is a digital camera that can capture images (still images and moving images), for example. FIG. 2 is a diagram illustrating an installation example of the imaging apparatuses 110. The imaging apparatuses 110 are installed in such a manner as to surround a specific region in a stadium, and capture images (videos) of a subject in the region.

Captured images are transmitted from the imaging apparatus 110 to the image generation apparatus 120. Only images corresponding to a part of regions (for example, regions of the subject), among captured images, are transmitted.

The image generation apparatus 120 is a server apparatus, for example, and includes a database function and an image processing function. The image generation apparatus 120 accumulates a preliminarily-captured image of a scene where a subject does not exist, such as a scene before the image capturing start of a subject in a playing field, as a background image. The image generation apparatus 120 also accumulates captured images obtained by the imaging apparatuses 110. If the image generation apparatus 120 receives virtual viewpoint information and reproduction time information (for example, time code) by a user operation of the display controlling apparatus 130, the image generation apparatus 120 generates a virtual viewpoint image based on accumulated captured images.

The virtual viewpoint information is information indicating a three-dimensional position of a virtual viewpoint (virtual viewpoint) in a virtual space, a line-of-sight direction from a virtual viewpoint, a field angle, and an observed point position. The virtual viewpoint information includes at least information regarding a relative position with respect to a predetermined origin position such as the center in a playing field included in captured images (i.e., anterior/posterior position, left/right position, or upper/lower position with respect to the origin position), and information regarding the orientation from the predetermined origin position (i.e., direction of angle with respect to a front-back, left-right, or up-down axis). The virtual viewpoint information also includes observed point position information indicating a three-dimensional position observed from a virtual viewpoint position, and distance information indicating a distance from an observed point position to the virtual viewpoint position.

Reproduction time information is time information indicating image capturing times of captured images that includes hours, minutes, seconds, and the number of frames per second. By designating a reproduction time, a scene recorded at the designated reproduction time is generated as a virtual viewpoint. For example, the number of frames per second is 60 frames or the like. Based on a time server (not illustrated), a plurality of imaging apparatuses 110 performs synchronous image capturing, and time information in image capturing indicates an image capturing timing of the plurality of imaging apparatuses 110.

In a scene where a subject exists, the image generation apparatus 120 may perform processing of separating a foreground such as a specific object serving as a subject, as a specific object image by image processing. The specific object may be an object of which an image patter is predefined, such as a tool including a ball in addition to persons.

A virtual viewpoint image corresponding to the virtual viewpoint information is generated from a background image managed in a database, and a specific object image. As a generation method of a virtual viewpoint image, for example, Model-Based Rendering (MBR) is used. The MBR is a method of generating a virtual viewpoint image using a three-dimensional shape generated based on a plurality of captured images of the subject captured from a plurality of directions. Specifically, the MBR is a technique of generating a view of a target scene from a virtual viewpoint, as an image, using a three-dimensional shape (model) of the target scene that is obtained by a three-dimensional shape reconstruction method such as Shape from Silhouette or Multi-View-Stereo (MVS). As the generation method of the virtual viewpoint image, a rendering method other than the MBR may be used. The generated virtual viewpoint image is transmitted to the display apparatus 140 via the video signal transmission cable.

The display controlling apparatus 130 is a personal computer (PC) or a tablet, for example. A viewpoint controller 131 is a device for setting parameters such as the position and the orientation of a virtual camera. For example, the viewpoint controller 131 is a mouse, a keyboard, a joystick, a six-axis controller, a touch panel, or a game controller. A time controller 132 is a device for setting a reproduction time, and is an operation device including a rotating disk, for example. The user operates the viewpoint controller 131 and the time controller 132. The display controlling apparatus 130 receives information regarding a user operation from the viewpoint controller 131 and the time controller 132. Then, in accordance with an amount of the operation, the display controlling apparatus 130 converts the user operation into virtual viewpoint information indicating the position and the orientation of a virtual camera, and reproduction time information, and transmits the converted information to the image generation apparatus 120.

The movement caused by the output from the display controlling apparatus 130 using the operation device is not limited to a continuous movement, and the movement to a preset predetermined virtual viewpoint such as a front position or a back position of a subject on a virtual space, or a position looking down at the subject can also be caused. By presetting a reproduction time, the time of a virtual viewpoint can also move instantly to the preset time. The display controlling apparatus 130 also displays, on a screen, an object on a three-dimensional space that is based on a user operation performed via an application displayed on a display unit 305 by the execution of a control program to be described below.

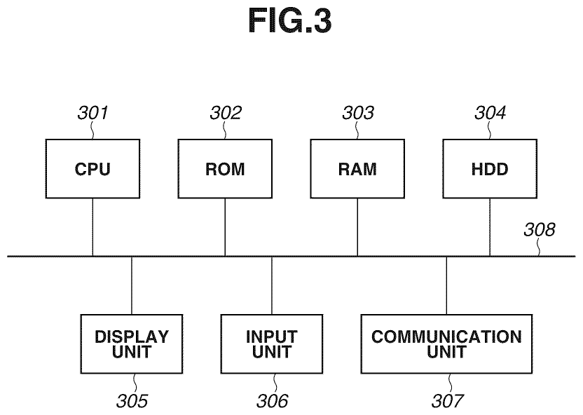

FIG. 3 is a diagram illustrating a hardware configuration of the display controlling apparatus 130. The display controlling apparatus 130 includes a central processing unit (CPU) 301, a read-only memory (ROM) 302, a random access memory (RAM) 303, a hard disc drive (HDD) 304, the display unit 305, an input unit 306, and a communication unit 307. The CPU 301 controls the entire display controlling apparatus 130 using control programs and data that are stored in the ROM 302 and the RAM 303. The display controlling apparatus 130 may include one or a plurality of dedicated hardware components different from the CPU 301, and the dedicated hardware components may execute at least part of processing to be executed by the CPU 301. Examples of such dedicated hardware components include an application specific integrated circuit (ASIC), Field Programmable Gate Array (FPGA), and a digital signal processor (DSP).

The ROM 302 stores programs that need not be changed. The RAM 303 temporarily stores programs and data that are supplied from the HDD 304, and data supplied from the outside via the communication unit 307. In addition, the RAM 303 is used as a temporary storage region such as a main memory and a work area of the CPU 301. The HDD 304 stores, various types of data and various programs.

The display unit 305 includes, for example, a liquid crystal display and a light-emitting diode (LED), and displays various types of information. The input unit 306 can connect to a keyboard, a mouse, and a six-axis controller, and receives various operations performed by the user. The communication unit 307 performs communication processing with an external apparatus via a network. Examples of the network include the Ethernet (registered trademark).

As another example, the communication unit 307 may wirelessly perform communication with an external apparatus.

A system bus 308 connects the components of the display controlling apparatus 130 and transmits information.

Functions and processing of the display controlling apparatus 130, which will be described below, are implemented by the CPU 301 reading out programs stored in the ROM 302 or the HDD 304, and executing the programs. The hardware configuration of the image generation apparatus 120 is similar to the hardware configuration of the display controlling apparatus 130.

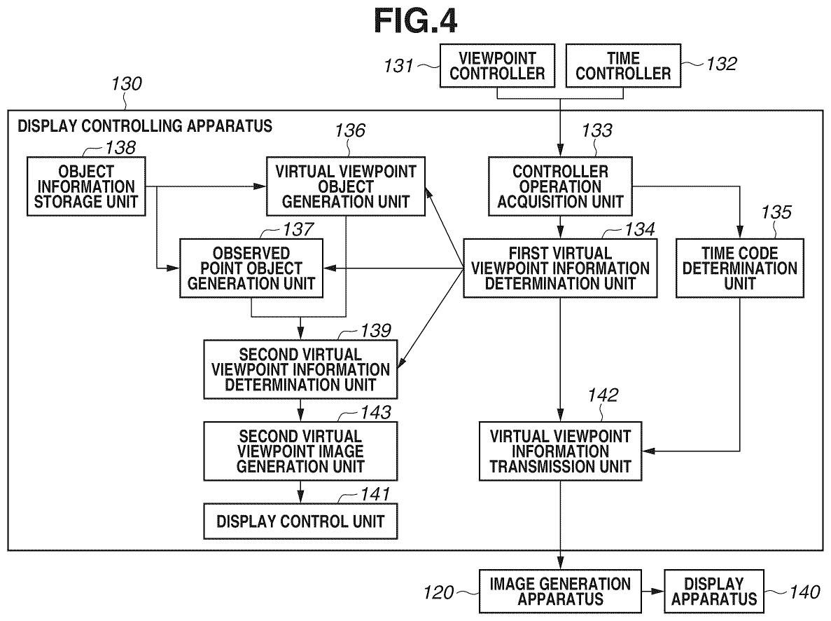

FIG. 4 is a diagram illustrating a functional configuration of the display controlling apparatus 130. A controller operation acquisition unit 133 cyclically acquires operation information on a virtual viewpoint that has been acquired via the viewpoint controller 131 and the time controller 132.

The controller operation acquisition unit 133 converts the operation information on the virtual viewpoint into virtual viewpoint movement amount information and reproduction time movement amount information, and outputs the virtual viewpoint movement amount information and the reproduction time movement amount information to a first virtual viewpoint information determination unit 134. The virtual viewpoint movement amount is a movement amount from a current position of a virtual viewpoint with respect to a line-of-sight direction from the virtual viewpoint. The reproduction time movement amount is a movement amount with respect to a current reproduction time. These pieces of information are determined by a set conversion coefficient for an operation amount of a user operation input to the viewpoint controller 131 or the time controller 132.

Based on the input virtual viewpoint movement amount information, the first virtual viewpoint information determination unit 134 determines virtual viewpoint information corresponding to the position of a virtual viewpoint designated by a user operation, and a line-of-sight direction from the virtual viewpoint. Then, the first virtual viewpoint information determination unit 134 outputs virtual viewpoint information to a virtual viewpoint object generation unit 136 as first virtual viewpoint information. The first virtual viewpoint information includes observed point position information indicating the position of an observed point corresponding to a first virtual viewpoint. The first virtual viewpoint information determination unit 134 similarly outputs the first virtual viewpoint information to an observed point object generation unit 137, a second virtual viewpoint information determination unit 139, and a virtual viewpoint information transmission unit 142. A virtual space coordinate system is the same as a coordinate system of each of the imaging apparatuses 110. For example, the center of the coordinate system may be set to the center of a stadium, or the center of the coordinate system may be appropriately set by the user. The virtual viewpoint information is represented as a position in a three-dimensional direction in this coordinate system. An observed point in the present disclosure refers to a point positioned on an optical axis of a virtual camera, and having a three-dimensional coordinate. A distance between the observed point and the virtual camera is determined based on a user operation.

A time code determination unit 135 determines reproduction time information designated by a user operation, based on an input reproduction time movement amount, and outputs the reproduction time information to the virtual viewpoint information transmission unit 142. The reproduction time is based on date and time on which image capturing is started by each of the imaging apparatuses 110. The reproduction time may be an image capturing time itself, or may be represented as an elapsed time from an image capturing start time set to 0.

The virtual viewpoint object generation unit 136 acquires the first virtual viewpoint information from the first virtual viewpoint information determination unit 134. The virtual viewpoint object generation unit 136 acquires virtual viewpoint object information from an object information storage unit 138 to be described below. Based on the first virtual viewpoint information and the virtual viewpoint object information, the virtual viewpoint object generation unit 136 generates a virtual viewpoint object that enables the user to recognize the position of a virtual viewpoint designated by a user operation on a virtual space, and a line-of-sight direction from the virtual viewpoint. The virtual viewpoint object includes data on a shape for representing a virtual viewpoint object, and position information on the space. The virtual viewpoint object generation unit 136 also outputs the virtual viewpoint object to the second virtual viewpoint information determination unit 139.

The observed point object generation unit 137 acquires the first virtual viewpoint information from the first virtual viewpoint information determination unit 134. The observed point object generation unit 137 also acquires observed point object information from the object information storage unit 138. The observed point object generation unit 137 generates, based on the observed point position information included in the first virtual viewpoint information and the observed point object information, an observed point object that enables the user to recognize the position of an observed point of a virtual viewpoint designated by a user operation on a virtual space. The observed point object includes data on a shape for representing an observed point object, and position information on the space. The observed point object generation unit 137 also outputs the observed point object to the second virtual viewpoint information determination unit 139.

The object information storage unit 138 prestores object information such as virtual viewpoint object information and observed point object information, and outputs corresponding object information.

That is, the object information storage unit 138 outputs virtual viewpoint object information to the virtual viewpoint object generation unit 136. The object information storage unit 138 outputs the observed point object information to the observed point object generation unit 137. The object information is a three-dimensional model, is data with a three-dimensional coordinate that is generated using dedicated software, and is data indicating a three-dimensional shape by linking a plurality of three-dimensional coordinates (vertices). By storing color information and texture images in association with a surface on which a plurality of vertices is linked, a user-recognizable object is obtained. For example, the object information may be mesh data including a plurality of polygons.

The second virtual viewpoint information determination unit 139 acquires a virtual viewpoint object from the virtual viewpoint object generation unit 136, and acquires an observed point object from the observed point object generation unit 137. The second virtual viewpoint information determination unit 139 also acquires first virtual viewpoint information from the first virtual viewpoint information determination unit 134. Based on the first virtual viewpoint information, the second virtual viewpoint information determination unit 139 determines second virtual viewpoint information based on which a virtual viewpoint object and an observed point object are displayable, and outputs the second virtual viewpoint information to a second virtual viewpoint image generation unit 143. Specifically, the second virtual viewpoint information is information indicating the position of a virtual viewpoint different from a virtual viewpoint operated by the user, and a line-of-sight direction from the virtual viewpoint. For example, the position of the virtual viewpoint indicated by the second virtual viewpoint information may be a position existing posteriorly to a first virtual viewpoint indicated by the first virtual viewpoint information (virtual viewpoint operated by the user). The line-of-sight direction from a second virtual viewpoint indicated by the second virtual viewpoint information may be an orientation in which an observed point object is displayable. The position of the second virtual viewpoint and the line-of-sight direction from the virtual viewpoint may be a position and an orientation where a virtual viewpoint object is displayable. The state in which the position of the second virtual viewpoint exists posteriorly to the position of the first virtual viewpoint refers not to a state in which the positions are connected on a straight line, but refers to a state in which the position of the second virtual viewpoint exists on a side opposite to an observed point side of the position of the first virtual viewpoint. The viewing field of the first virtual viewpoint that is identified by the first virtual viewpoint information does not include the position of the second virtual viewpoint. On the other hand, the viewing field of the second virtual viewpoint includes the position of the first virtual viewpoint and the position of the observed point.

The displayable state means a state of being displayable in a virtual viewpoint image generated based on the second virtual viewpoint information, in a display apparatus. In this virtual viewpoint image, a virtual viewpoint object and an observed point object need not be simultaneously displayed. For example, a case where an observed point object is displayed and a virtual viewpoint object is not displayed may be caused. Alternatively, for example, either object may be hidden in accordance with a display instruction issued by a user. In addition, these objects may be translucently displayed. In this case, these objects are prevented from being shielded by each other, and it becomes easier for the user to recognize an object. In a case where a subject exists on a virtual viewpoint image, the subject is prevented from being shielded, and it becomes easier for the user to recognize the subject.

The second virtual viewpoint image generation unit 143 acquires the second virtual viewpoint information from the second virtual viewpoint information determination unit 139, and generates a second virtual viewpoint image including a virtual viewpoint object and an observed point object, based on the second virtual viewpoint information. The second virtual viewpoint image may be generated based on the imaging apparatus 110, or may be generated based on a background model of a stadium that is prestored in the image generation apparatus 120. The second virtual viewpoint image may be generated by a display control unit 141. The second virtual viewpoint image generation unit 143 transmits the generated second virtual viewpoint image to the display control unit 141.

The display control unit 141 performs the control of displaying the second virtual viewpoint image acquired from the second virtual viewpoint image generation unit 143. That is, by displaying the second virtual viewpoint image on the display unit 305 of the display controlling apparatus 130, the display control unit 141 displays the position of a virtual camera (first virtual viewpoint) that is based on a virtual viewpoint operation performed by the user, and an observed point thereof. The display is performed in the second virtual viewpoint image generated based on the second virtual viewpoint information.

The virtual viewpoint information transmission unit 142 transmits the first virtual viewpoint information input by the first virtual viewpoint information determination unit 134, and the reproduction time information input by the time code determination unit 135, to the image generation apparatus 120. A virtual viewpoint image generated by the image generation apparatus 120 based on the virtual viewpoint information and the reproduction time information is output to the display apparatus 140 and displayed thereon. The virtual viewpoint image generated by the image generation apparatus 120 is a first virtual viewpoint image viewed from a first virtual viewpoint, and differs from a second virtual viewpoint image viewed from a second virtual viewpoint.

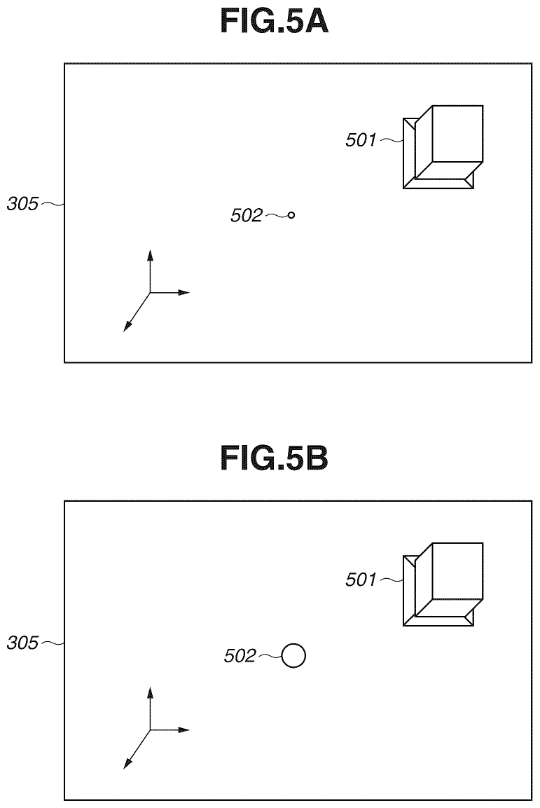

FIGS. 5A and 5B each illustrate an example in which a second virtual viewpoint image is displayed on the display unit 305. A virtual viewpoint object 501 and an observed point object 502 are displayed on a screen of the display unit 305 of the display controlling apparatus 130. In the present exemplary embodiment, as a distance between the position of a virtual viewpoint and the position of an observed point in a virtual space becomes larger (longer), a size of an observed point object is made larger. For example, FIG. 5A illustrates an example in which a distance between the position of a virtual viewpoint and the position of an observed point is large, but a size of an observed point object is not changed. An observed point object far away from a second virtual viewpoint appears small, and visibility declines. In FIG. 5B, the size of an observed point object is increased by processing to be described below, and the observed point object appears in a larger size in the second virtual viewpoint image, whereby visibility improves.

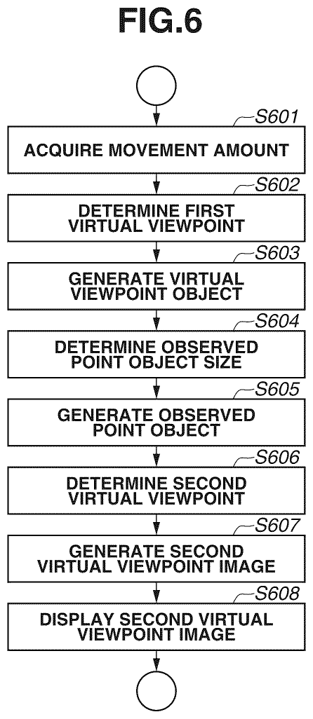

FIG. 6 is a flowchart illustrating an operation of the display controlling apparatus 130 according to the present exemplary embodiment. The following processing is performed by the CPU 301 reading out a program stored in the ROM 302 or the HDD 304, and executing the program.

In step S601, the controller operation acquisition unit 133 acquires movement amount information of a lever of a six-axis controller such as a joystick from the viewpoint controller 131. The controller operation acquisition unit 133 also acquires movement amount information of a rotating disk rotated by the user, for example, from the time controller 132. Next, the controller operation acquisition unit 133 converts the movement amount information pieces acquired from the viewpoint controller 131 and the time controller 132, into virtual viewpoint movement amount information and reproduction time movement amount information, and outputs the virtual viewpoint movement amount information and the reproduction time movement amount information to the first virtual viewpoint information determination unit 134.

In step S602, the first virtual viewpoint information determination unit 134 determines first virtual viewpoint information based on the input virtual viewpoint movement amount information. Then, the first virtual viewpoint information determination unit 134 outputs the first virtual viewpoint information to the virtual viewpoint object generation unit 136, the observed point object generation unit 137, and the object information storage unit 138. The first virtual viewpoint is a virtual viewpoint to be operated by the user, and is a virtual viewpoint corresponding to a virtual viewpoint image to be displayed on the display apparatus 140.

In step S603, the virtual viewpoint object generation unit 136 generates a virtual viewpoint object. Specifically, the virtual viewpoint object generation unit 136 acquires virtual viewpoint information from the first virtual viewpoint information determination unit 134. The virtual viewpoint object generation unit 136 also acquires virtual viewpoint object information from the object information storage unit 138. Based on the virtual viewpoint information and the virtual viewpoint object information, the virtual viewpoint object generation unit 136 generates a virtual viewpoint object that enables the user to recognize the position of a first virtual viewpoint on a virtual space, and a line-of-sight direction from the first virtual viewpoint. For example, a virtual viewpoint object may have a shape of a camera, and may have another shape.

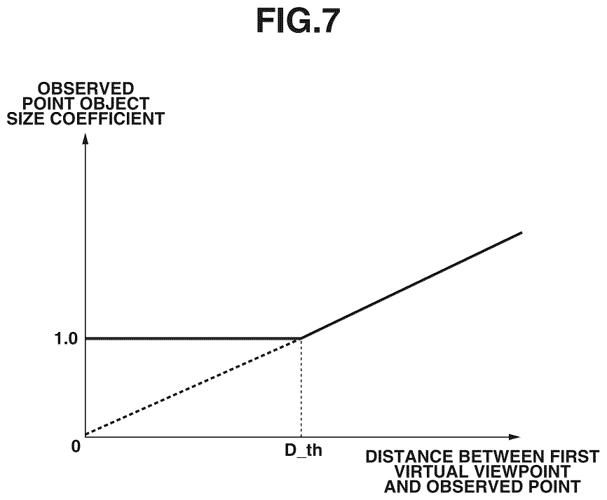

In step S604, the observed point object generation unit 137 determines the size of an observed point object. Specifically, the observed point object generation unit 137 acquires virtual viewpoint information from the first virtual viewpoint information determination unit 134. From the position of a first virtual viewpoint and the position of an observed point that are included in the virtual viewpoint information, the observed point object generation unit 137 calculates a distance between the position of the first virtual viewpoint and the position of the observed point. Next, based on a graph illustrated in FIG. 7 that indicates a relationship between a distance between the position of the first virtual viewpoint and the position of the observed point, and the size of an observed point object, the observed point object generation unit 137 determines the size of an observed point object. In a case where a distance between the position of the first virtual viewpoint and the position of the observed point is smaller than a threshold value D_th, a size coefficient of an observed point object is set to 1.0. The size coefficient is a coefficient indicating a size expansion degree with respect to a default value of the size of the observed point object. That is, the observed point object generation unit 137 determines the size of the acquired observed point object to be the same size. The threshold value D_th may be separately set by the user, or may be determined depending on an image capturing target. For example, in the case of generating a virtual viewpoint image by capturing images of baseball, based on a distance between a home base and a second base, for example, the threshold value D_th is defined as 40 m. Next, in a case where a distance between the position of the first virtual viewpoint and the position of the observed point is equal to or larger than the threshold value D_th, a size coefficient of an observed point object is linearly determined, and a size is determined by adding a numerical value obtained by multiplying the size coefficient by a predetermined value, to a default value of the size of the observed point object. Nevertheless, the determination of the size coefficient is not limited to this, and the size coefficient may be nonlinearly determined in such a manner as to become larger as the distance gets farther. The size may be determined by multiplying of the default value of the size of the observed point object by the size coefficient. The predetermined value in the multiplication of the size coefficient is separately set by the user. With this configuration, in a case where a first virtual viewpoint gets away from an observed point by the threshold value D_th or more, an observed point object is linearly (proportionately) enlarged. The design of a function for determining a size coefficient is not limited to this example, and a nonlinear function may be used. It is sufficient that a distance and a size coefficient has a positive correlative relationship. By designing of a size coefficient of a distance equal to or smaller than the threshold value D_th, to a value smaller than 1.0, an observed point may be scaled down to prevent the observed point from appearing too large when getting closer to the first virtual viewpoint in such a manner that a distance therebetween becomes smaller than the threshold value D_th. Nevertheless, because it is desirable, from the viewpoint of continuousness of operations, that the size of an observed point continuously changes, it is desirable that a function for determining a size coefficient is continuous as well.

In step S605, the observed point object generation unit 137 generates an observed point object. Specifically, the observed point object generation unit 137 acquires observed point object information from the object information storage unit 138. Based on observed point position information included in virtual viewpoint information and observed point object information, the observed point object generation unit 137 generates an observed point object that enables the user to recognize the position of an observed point of the first virtual viewpoint on the virtual space. The size of the generated observed point object is the size determined in step S604. The observed point object may have a spherical shape or may have a quadrangular prism shape.

In step S606, the second virtual viewpoint information determination unit 139 determines second virtual viewpoint information. Specifically, the second virtual viewpoint information determination unit 139 acquires first virtual viewpoint information from the first virtual viewpoint information determination unit 134. The second virtual viewpoint information determination unit 139 also acquires a virtual viewpoint object and an observed point object. The second virtual viewpoint information determination unit 139 determines second virtual viewpoint information based on the acquired information. The second virtual viewpoint information is information indicating a second virtual viewpoint where images of a virtual viewpoint object and an observed point object can be virtually captured. More specifically, the position of the second virtual viewpoint is a posterior position distant from the position of the first virtual viewpoint by a predetermined distance, and the second virtual viewpoint information is determined in such a manner that a line-of-sight direction from the second virtual viewpoint becomes a direction from which an image of an observed point object can be virtually captured. The second virtual viewpoint information determination unit 139 outputs the second virtual viewpoint information to the display control unit 141.

In step S607, the second virtual viewpoint image generation unit 143 generates a second virtual viewpoint image. Specifically, the second virtual viewpoint image generation unit 143 acquires the second virtual viewpoint information from the second virtual viewpoint information determination unit 139, and generates a second virtual viewpoint image including a virtual viewpoint object and an observed point object, based on the second virtual viewpoint information. The second virtual viewpoint image generation unit 143 outputs the generated second virtual viewpoint image to the display control unit 141.

In step S608, the display control unit 141 acquires the second virtual viewpoint image from the second virtual viewpoint image generation unit 143. Next, the display control unit 141 displays the second virtual viewpoint image including the virtual viewpoint object and the observed point object, on the display unit 305 of the display controlling apparatus 130.

A first virtual viewpoint that is based on a virtual viewpoint operation performed by the user, an observed point thereof, and the position of the observed point on the virtual space are thereby displayed. It accordingly becomes possible for the user to easily recognize the position of the observed point on the virtual space.

As described above, in the present exemplary embodiment, by an increase in the size of an observed point object when a distance between the position of a first virtual viewpoint and the position of an observed point is larger than a threshold value, the visibility of an observed point in a second virtual viewpoint image to be referred to by the user when operating the first virtual viewpoint is improved.

In the present exemplary embodiment, a second virtual viewpoint is set at a posterior position distant from a virtual viewpoint by a predetermined distance, but the position of the second virtual viewpoint is not limited to this. For example, the second virtual viewpoint may be set at a position near an observed point, and in this case, the second virtual viewpoint is determined on the side opposite to a first virtual viewpoint with respect to the observed point in such a manner that a virtual viewpoint object falls within a field angle. In this case, the size of the virtual viewpoint object is changed in accordance with a distance between the virtual viewpoint object and an observed point object. In addition, the second virtual viewpoint may be determined at a position distant from both of an observed point and a virtual viewpoint, and in this case, the sizes of both a observed point object and a virtual viewpoint object are changed.

In the present exemplary embodiment, the visibility of an observed point or a virtual viewpoint is improved by changing the size of each object, but another parameter related to object display may be changed. For example, the color of an object that is included in parameters may be changed totally or partially such as an outline portion. Moreover, visibility may be improved by cyclically changing the size and the color of an object.

Moreover, the definition of object information is not limited to a three-dimensional model. An object may be stored and input as an object to be drawn with always directly facing a second virtual viewpoint, like a two-dimensional image, and the size of the object may be changed.

In the present exemplary embodiment, the display apparatus 140 and the display unit 305 have been described as separate blocks, but the configuration is not limited to this. For example, a second virtual viewpoint image may be displayed on the display apparatus 140.

A multiwindow configuration including a window for displaying a first virtual viewpoint image and a window for displaying a second virtual viewpoint image can be employed, and the first virtual viewpoint image and the second virtual viewpoint image can also be displayed simultaneously.

The virtual viewpoint information has been described using a three-dimensional position and a line-of-sight direction from a virtual viewpoint, but the virtual viewpoint information is not limited to this. The virtual viewpoint information may be information indicating an orientation including rotation and a field angle.

### Modified Example of First Exemplary Embodiment

In the first exemplary embodiment, the size of an observed point object is changed in accordance with a distance between a first virtual viewpoint and an observed point. Alternatively, the size of an observed point object may be changed in accordance with their three-dimensional positions. Hereinafter, the description of configurations similar to those in the first exemplary embodiment will be omitted.

In step S604, the observed point object generation unit 137 and the virtual viewpoint object generation unit 136 determine the sizes of objects in such a manner as to become a predetermined size in a case where three-dimensional positions of the objects are included in a predetermined partial space. For example, in a case where baseball is set as an image capturing target, when a three-dimensional position of a first virtual viewpoint falls within a spherical partial space with a radius of 20 m from a home base, a size coefficient in processing of determining the size of an observed point object is set to 1.0. In a case where the three-dimensional position of the first virtual viewpoint falls outside the partial space and falls within a space with a radius of 40 m from the home base, the size coefficient is set to 2.0. In a case where the three-dimensional position of the first virtual viewpoint falls outside the partial space and falls outside the space with the radius of 40 m from the home base, the size coefficient is set to 3.0. As described above, by setting at least one predetermined partial space in a virtual space, and setting a parameter such as a size coefficient of an observed point object in each partial space, it is possible to determine the size of an observed point object in accordance with the position of a first virtual viewpoint.

As a result of the above-described processing, it is possible to improve the visibility of an observed point, and at the same time, it becomes possible to intuitively recognize a space to which a virtual viewpoint belongs.

According to the present disclosure, the user can easily recognize the position of an observed point of a virtual viewpoint on a virtual space.

In the first exemplary embodiment, the size of an observed point object is determined in accordance with a distance between a first virtual viewpoint and an observed point, but in a second exemplary embodiment, the size of an observed point object is determined in accordance with a distance between a second virtual viewpoint and an observed point. Hereinafter, the description of configurations similar to those in the first exemplary embodiment will be omitted.

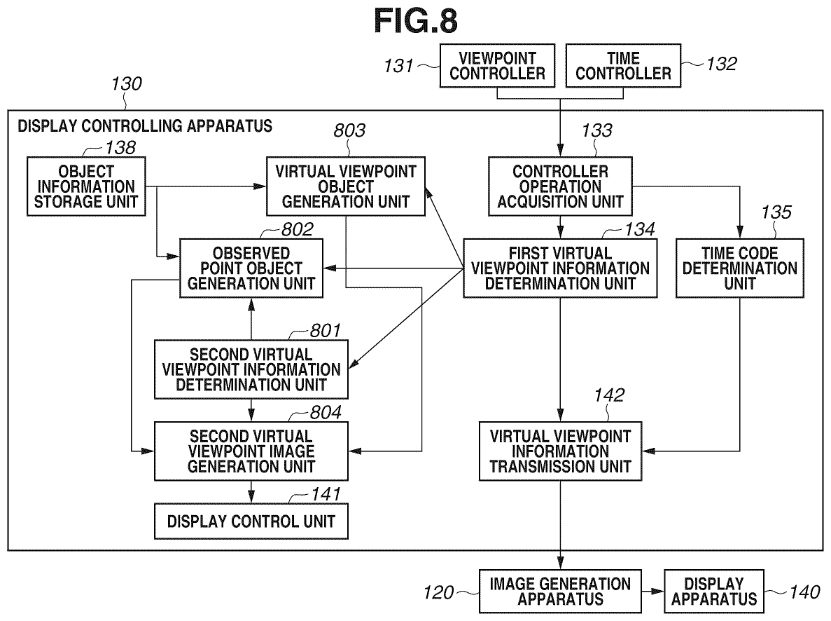

FIG. 8 is a diagram illustrating a functional configuration of a display controlling apparatus 130 according to the second exemplary embodiment.

A second virtual viewpoint information determination unit 801 acquires first virtual viewpoint information from the first virtual viewpoint information determination unit 134. Next, based on the first virtual viewpoint information, the second virtual viewpoint information determination unit 801 determines second virtual viewpoint information indicating a second virtual viewpoint of which a field angle includes a first virtual viewpoint and an observed point. Because the position of the second virtual viewpoint and a line-of-sight direction from the second virtual viewpoint are the same as those in the first exemplary embodiment, the description will be omitted. The second virtual viewpoint information determination unit 801 outputs the determined second virtual viewpoint information to an observed point object generation unit 802.

The observed point object generation unit 802 acquires observed point object information from the object information storage unit 138. The observed point object generation unit 802 also acquires first virtual viewpoint information from the first virtual viewpoint information determination unit 134. The observed point object generation unit 802 also acquires second virtual viewpoint information from the second virtual viewpoint information determination unit 801. Based on observed point position information included in the acquired first virtual viewpoint information, and the second virtual viewpoint information, the observed point object generation unit 802 determines the size of an observed point object. Specifically, the observed point object generation unit 802 determines the size of an observed point object based on a distance between a second virtual viewpoint and an observed point. Next, the observed point object generation unit 802 generates an observed point object with the determined size, and outputs the generated observed point object to a second virtual viewpoint image generation unit 804.

A virtual viewpoint object generation unit 803 acquires first virtual viewpoint information from the first virtual viewpoint information determination unit 134. The virtual viewpoint object generation unit 803 also acquires virtual viewpoint object information from the object information storage unit 138 to be described below. Based on the first virtual viewpoint information and the virtual viewpoint object information, the virtual viewpoint object generation unit 803 generates a virtual viewpoint object that enables the user to recognize the position of a virtual viewpoint designated by a user operation on a virtual space, and a line-of-sight direction from the virtual viewpoint. The virtual viewpoint object generation unit 803 outputs the generated virtual viewpoint object to the second virtual viewpoint image generation unit 804.

The second virtual viewpoint image generation unit 804 acquires second virtual viewpoint information from the second virtual viewpoint information determination unit 801. The second virtual viewpoint image generation unit 804 also acquires an observed point object from the observed point object generation unit 802. The second virtual viewpoint image generation unit 804 also acquires a virtual viewpoint object from the virtual viewpoint object generation unit 803. Based on second virtual viewpoint information, the second virtual viewpoint image generation unit 804 generates a second virtual viewpoint image including the observed point object and the virtual viewpoint object. The second virtual viewpoint image generation unit 804 transmits the generated second virtual viewpoint image to the display control unit 141.

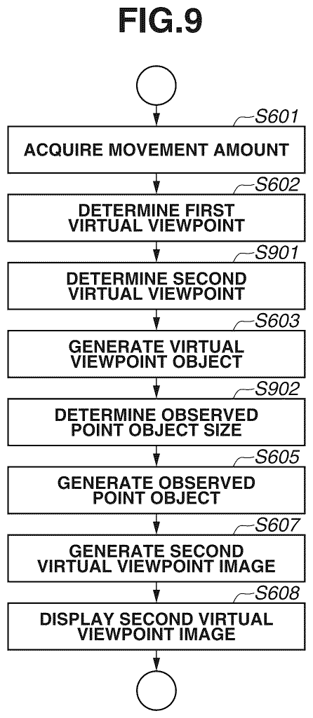

FIG. 9 is a flowchart illustrating an operation of a display controlling apparatus 130 according to the second exemplary embodiment. The following processing is performed by the CPU 301 reading out a program stored in the ROM 302 or the HDD 304, and executing the program. The description of steps in which the same processing as that in the flowchart illustrated in FIG. 6 is performed will be omitted.

In step S901, the second virtual viewpoint information determination unit 801 acquires first virtual viewpoint information from the first virtual viewpoint information determination unit 134. Next, based on the first virtual viewpoint information, the second virtual viewpoint information determination unit 801 determines second virtual viewpoint information indicating a second virtual viewpoint of which a field angle includes a first virtual viewpoint and an observed point. Because the position of the second virtual viewpoint and a line-of-sight direction from the second virtual viewpoint are the same as those in the first exemplary embodiment, the description will be omitted. The second virtual viewpoint information determination unit 801 outputs the determined second virtual viewpoint information to the observed point object generation unit 802.

In step S902, the observed point object generation unit 802 generates an observed point object. Specifically, based on observed point position information included in the acquired first virtual viewpoint information, and the second virtual viewpoint information, the observed point object generation unit 802 determines the size of an observed point object. Specifically, the observed point object generation unit 802 determines the size of an observed point object based on a distance between a second virtual viewpoint and an observed point.

Through the above-described processing, the size of an observed point object is determined based on a distance between a second virtual viewpoint and an observed point, and the visibility of an observed point in a second virtual viewpoint image can be improved.

In the first exemplary embodiment, the size of a spherical observed point object is determined in accordance with a distance between a first virtual viewpoint and an observed point, but in a third exemplary embodiment, the description will be given of an example in which the type of an observed point object is replaced with an object in an actual scale. In the present exemplary embodiment, when a distance between a first virtual viewpoint and an observed point becomes smaller than a threshold value, the user is enabled to easily recognize an appropriate distance in virtual viewpoint image generation. Hereinafter, the description of configurations similar to those in the first exemplary embodiment will be omitted.

The object information storage unit 138 stores, as an example of the type of an observed point object, for example, a preliminarily-generated three-dimensional model of a baseball player in addition to a sphere described in the first exemplary embodiment. At this time, the object information storage unit 138 may store a plurality of three-dimensional models of the same type by deforming the shape of a three-dimensional model of the same type as time advances. The type of the observed point object is not limited to the above-described type. For example, the color of an observed point object may be changed in accordance with a distance between a first virtual viewpoint and an observed point. Alternatively, in a case where a distance between a first virtual viewpoint and an observed point becomes equal to or smaller than a threshold value, the outline of an observed point object on a virtual viewpoint image may be enhanced.

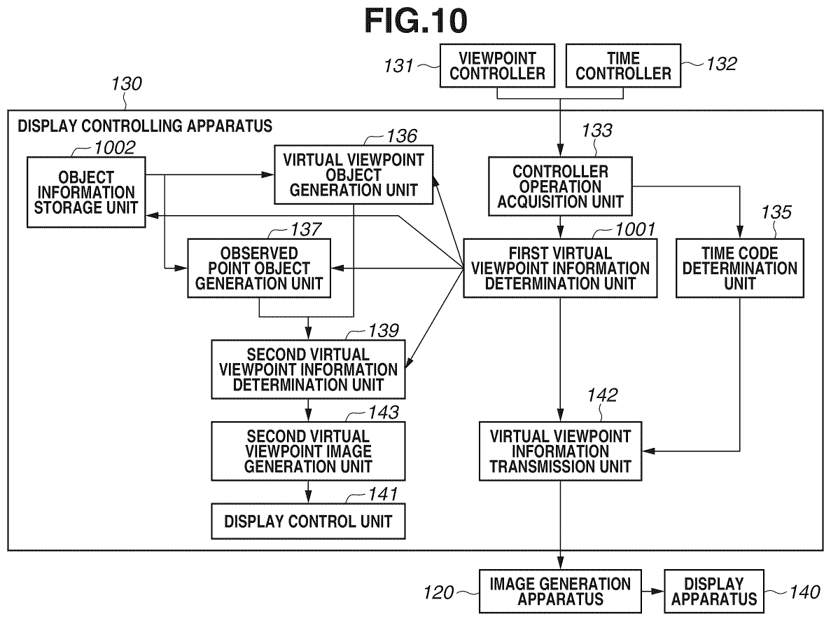

FIG. 10 is a diagram illustrating a functional configuration of a display controlling apparatus 130 according to the present exemplary embodiment.

Based on the input virtual viewpoint movement amount information, a first virtual viewpoint information determination unit 1001 determines virtual viewpoint information corresponding to the position of a virtual viewpoint designated by a user operation, and a line-of-sight direction from the virtual viewpoint. The generated virtual viewpoint information is similar to that in the first exemplary embodiment. Then, the first virtual viewpoint information determination unit 1001 outputs the generated virtual viewpoint information to an object information storage unit 1002 as first virtual viewpoint information.

The object information storage unit 1002 acquires first virtual viewpoint information from the first virtual viewpoint information determination unit 1001. Based on the acquired first virtual viewpoint information, the object information storage unit 1002 determines an observed point object to be displayed in a second virtual viewpoint image, among a plurality of prestored observed point objects. Specifically, in a case where a distance between a first virtual viewpoint and an observed point is smaller than a threshold value D_th2, the object information storage unit 1002 determines a stored three-dimensional model indicating the shape of a baseball player, as an observed point object. In a case where a distance between a first virtual viewpoint and an observed point is equal to or larger than the threshold value D_th2, similarly to the first exemplary embodiment, the object information storage unit 1002 determines a spherical three-dimensional model as an observed point object.

The object information storage unit 1002 outputs the determined object to the observed point object generation unit 137.

By generating a three-dimensional model of a baseball player that is to be preliminarily generated, based on a plurality of captured images, when a distance between a first virtual viewpoint and an observed point is smaller than the threshold value D_th2, it is possible to generate a three-dimensional model with a size close to the size of an actual baseball player, as an observed point object.

Alternatively, a rectangular parallelepiped with the height of 1 m may be set as a three-dimensional model to be preliminarily generated. The three-dimensional model to be preliminarily generated is only required to be different from a three-dimensional model to be determined to be an observed point object when a distance between a first virtual viewpoint and an observed point is equal to or larger than the threshold value D_th2.

Through the above-described processing, an observed point object to be displayed when a distance between a first virtual viewpoint and an observed point is smaller than the threshold value D_th2, and an observed point object to be displayed when a distance between a first virtual viewpoint and an observed point is equal to or larger than the threshold value D_th2 become different three-dimensional models. Consequently, the user can recognize a distance between a first virtual viewpoint and an observed point more intuitively.

In the present exemplary embodiment, the description has been given of an example in which the type of an observed point object is changed in accordance with a distance between a first virtual viewpoint and an observed point, but the example is not limited to the above-described example. For example, in a case where a distance between a first virtual viewpoint and an observed point becomes equal to or larger than a threshold value, a text indicating an approximate position of an observed point may be displayed in a second virtual viewpoint image. Specifically, it is assumed that baseball is an image capturing target, a threshold value is set to 20 m, a distance between a first virtual viewpoint and an observed point is 25 m, and the position of an observed point is located at a position within 3 m from a three-dimensional position of a home base. At this time, a text indicating “near the home base” may be displayed near an observed point object on a second virtual viewpoint image. A condition for displaying a text such as “within 3 m from the three-dimensional position of the home base” is preset for each text. With this configuration, the user can easily recognize an approximate position of an observed point.

In the first exemplary embodiment, the description has been given of the method of improving the visibility of an observed point on a second virtual viewpoint image by increasing the size of an observed point object when a distance between a first virtual viewpoint and an observed point is large. In a fourth exemplary embodiment, the description will be given of a method of making the position of an observed point recognizable more accurately, by further generating and displaying a background object and a guide object for supplementarily presenting a mutual positional relationship. Hereinafter, the description of configurations similar to those in the first exemplary embodiment will be omitted.

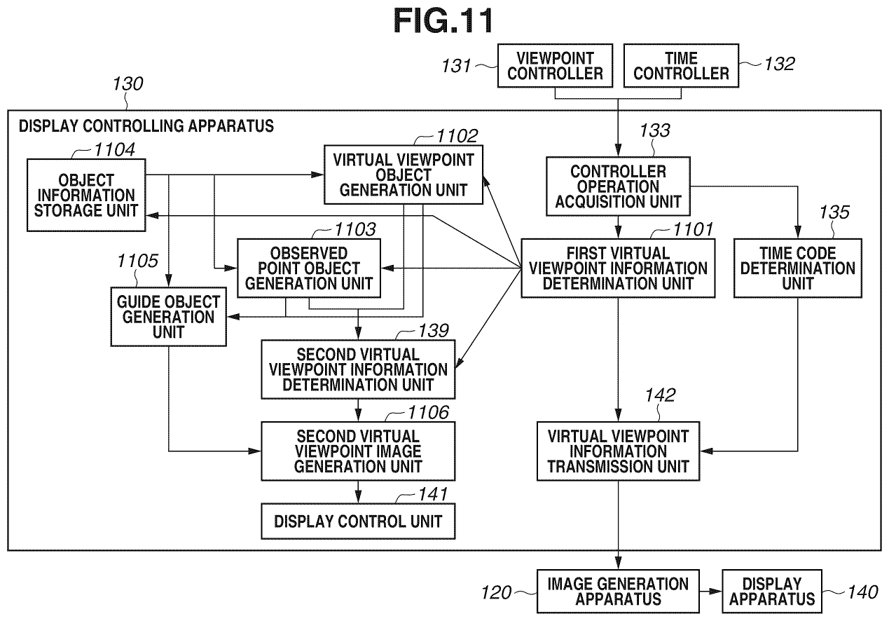

FIG. 11 illustrates a functional configuration of a display controlling apparatus 130 according to the present exemplary embodiment.

In addition to the function of the first virtual viewpoint information determination unit 134 described with reference to FIG. 4, a first virtual viewpoint information determination unit 1101 outputs generated first virtual viewpoint information to a guide object generation unit 1105.

In addition to the function of the virtual viewpoint object generation unit 136 described with reference to FIG. 4, a virtual viewpoint object generation unit 1102 outputs a generated virtual viewpoint object to the guide object generation unit 1105.

In addition to the function of the observed point object generation unit 137 described with reference to FIG. 4, an observed point object generation unit 1103 outputs a generated observed point object to the guide object generation unit 1105.

In addition to the function of the object information storage unit 138 described with reference to FIG. 4, an object information storage unit 1104 stores a background object being a three-dimensional model of a baseball stadium, for example. The object information storage unit 1104 stores a plurality of types of background objects, and outputs a background object selected by a user operation, to the guide object generation unit 1105. The background object to be output is not limited to this, and the background object to be output may be determined based on a captured image, from among a plurality of types of background objects.

The guide object generation unit 1105 generates a guide object by inputting observed point information, virtual viewpoint information, and the background object. The guide object generation unit 1105 outputs the generated guide object to a second virtual viewpoint image generation unit 1106. As described below, the guide object is a three-dimensional model of a line or a surface, for example.

The second virtual viewpoint image generation unit 1106 generates a second virtual viewpoint image including the acquired guide object. The second virtual viewpoint image generation unit 1106 outputs the generated second virtual viewpoint image to the display control unit 141.

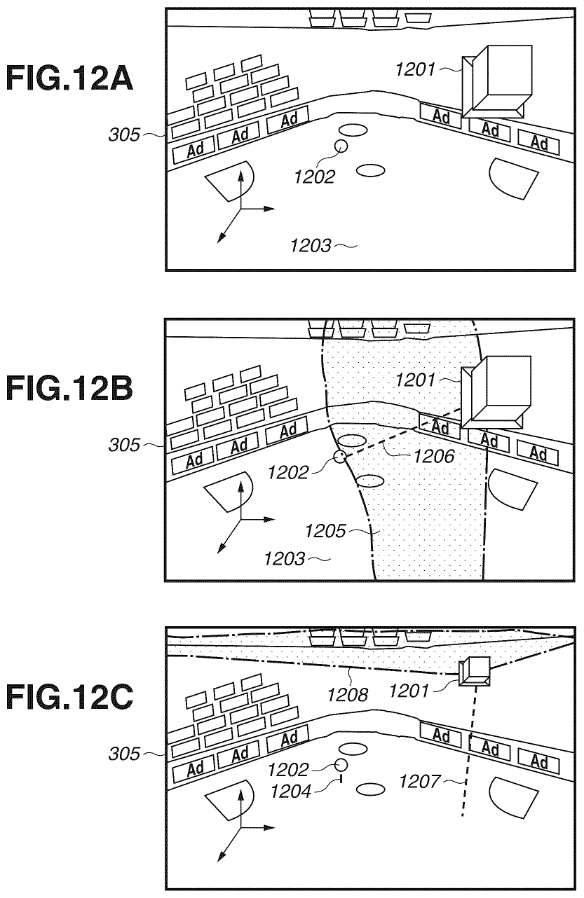

FIGS. 12A to 12C each illustrate a display example of a guide object according to the present exemplary embodiment.

In FIG. 12A, a guide object is not displayed, and a three-dimensional model of a baseball stadium is displayed as a background object 1203, and similarly to the first exemplary embodiment, a virtual viewpoint object 1201 and an observed point object 1202 are displayed.

In FIG. 12B, a linear object 1206 extending from a first virtual viewpoint to an observed point, and a surface 1205 vertically slicing a three-dimensional virtual space such as a space including the linear object 1206, from the position and the orientation of a first virtual viewpoint are displayed as guide objects. Here, the surface 1205 is displayed with limiting an angle range in a vertical direction in accordance with a field angle of the first virtual viewpoint.

The surface 1205 extends up to a point intersecting with the background object 1203, and a broken line includes a contact point with the background object 1203. Based on the guide objects, it becomes possible to more intuitively recognize the orientation of the first virtual viewpoint, a positional relationship with the background object 1203, and a line-of-sight direction.

In FIG. 12C, a linear object 1204 and a linear object 1207 extending from an observed point and a first virtual viewpoint vertically-downward toward the background object 1203 are displayed as guide objects. In addition, a surface 1208 horizontally slicing a three-dimensional virtual space from the first virtual viewpoint toward the background object 1203 is displayed.

Similarly to the surface 1205, the surface 1208 is displayed with limiting an angle range in accordance with the field angle of the first virtual viewpoint. Because the surface 1208 horizontally extends toward the background object 1203, the surface 1208 has contact with a stadium audience seats second-floor portion of the background object 1203. Based on these guide objects, it becomes possible to more intuitively recognize the heights and positions in an infield range of an observed point and a first virtual viewpoint.

As described above, by generating and displaying a guide object for supplementarily presenting a mutual positional relationship between objects, it becomes possible to more intuitively recognize a field angle from a first virtual viewpoint and the arrangement of an observed point and the first virtual viewpoint.

In accordance with the texture of a background, the color of each object may be set to a color with high visibility, such as a complementary color of an average value of colors of the background around the object.

### Adjustment of Size of Observed Point Object on Virtual Viewpoint Image

In the first exemplary embodiment, the size of a spherical observed point object is determined in accordance with a distance between a first virtual viewpoint and an observed point. In a fifth exemplary embodiment, the description will be given of an example of controlling sizes of a virtual viewpoint object and an observed point object on a second virtual viewpoint image to become the same size irrespective of a distance between a second virtual viewpoint and an observed point.

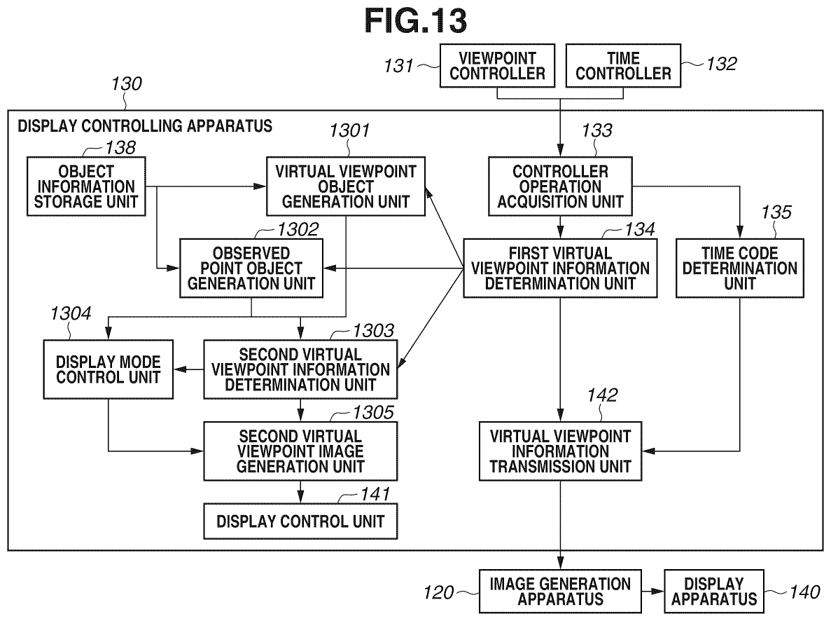

FIG. 13 illustrates a functional configuration of a display controlling apparatus 130 according to the present exemplary embodiment.

In addition to the function of the virtual viewpoint object generation unit 136 described with reference to FIG. 4, a virtual viewpoint object generation unit 1301 outputs a generated virtual viewpoint object to a display mode control unit 1304.

In addition to the function of the observed point object generation unit 137 described with reference to FIG. 4, an observed point object generation unit 1302 outputs generated observed point object to the display mode control unit 1304.

While the observed point object generation unit 137 determines the size of an observed point object in the first exemplary embodiment, the observed point object generation unit 137 does not determine the size of an observed point object in the present exemplary embodiment.

In addition to the function of the second virtual viewpoint information determination unit 139 described with reference to FIG. 4, a second virtual viewpoint information determination unit 1303 outputs generated second virtual viewpoint information to the display mode control unit 1304.

The display mode control unit 1304 acquires a virtual viewpoint object from the virtual viewpoint object generation unit 1301. The display mode control unit 1304 acquires an observed point object from the observed point object generation unit 1302. The display mode control unit 1304 acquires second virtual viewpoint information from the second virtual viewpoint information determination unit 1303. Based on the above-described acquired information, the display mode control unit 1304 controls the sizes of a virtual viewpoint object and an observed point object on a second virtual viewpoint image to become the same size irrespective of a distance between a second virtual viewpoint and an observed point. The sizes are made individually settable by the user.

Through the above-described processing, because the sizes of a virtual viewpoint object and an observed point object on a second virtual viewpoint image are controlled to become the same size, it is possible to improve the visibility of the virtual viewpoint object and the observed point object.

The description has been given of an example of controlling the sizes of a virtual viewpoint object and an observed point object on a second virtual viewpoint image to become the same size irrespective of a distance between a second virtual viewpoint and an observed point, but control is not limited to this. For example, the sizes of a virtual viewpoint object and an observed point object on a second virtual viewpoint image may be controlled to become the same size irrespective of a distance between a first virtual viewpoint and an observed point. Alternatively, control may be performed in such a manner that the size of either one of a virtual viewpoint object and an observed point object on a second virtual viewpoint image becomes the same size.

The description has been given of an example of controlling the sizes of a virtual viewpoint object and an observed point object on a second virtual viewpoint image to become the same size irrespective of a distance between a second virtual viewpoint and an observed point, but control is not limited to this. For example, the sizes of a virtual viewpoint object and an observed point object on a second virtual viewpoint image may be controlled to become sizes falling within a predetermined range. Specifically, the range of the sizes of a virtual viewpoint object and an observed point object on a second virtual viewpoint image is preliminarily designated. For example, a square frame surrounding a virtual viewpoint object and an observed point object on a second virtual viewpoint image is set, and a range with a size corresponding to one side of the frame is set. As the range of the size, a range of a size easily-viewable by the user is preset. In this example, the range is set in such a manner that the size of one side becomes five to ten pixels. A first threshold value and a second threshold value larger than the first threshold value are preliminarily provided for a distance between a second virtual viewpoint and an observed point, and in a case where the distance is smaller than the first threshold value, control is performed in such a manner that the size of one side of the frame becomes five pixels. In a case where the distance is equal to or larger than the first threshold value and smaller than the second threshold value, control is performed in such a manner that the size of one side of the frame becomes the size within the range of five to ten pixels. At this time, the distance and the size of one side are in a correlative relationship, and may be in a proportional relationship, for example. In a case where the distance is equal to or larger than the second threshold value, the size of one side of the frame is controlled to become ten pixels. The above-described processing is rephrased as an example of controlling the sizes of a virtual viewpoint object and an observed point object on a second virtual viewpoint image to become sizes falling within a predetermined range. Thus, a difference between the size of an object indicating an observed point on a second virtual viewpoint image in a case where a distance between a second virtual viewpoint and an observed point is a first distance, and the size of an object indicating an observed point on a second virtual viewpoint image in a case where a distance between a second virtual viewpoint and an observed point is a second distance different from the first distance falls within a predetermined range.

Through the above-described processing, it is possible to display a virtual viewpoint object and an observed point object in sizes easily-viewable for the user irrespective of a distance between a second virtual viewpoint and an observed point. Because sizes of a virtual viewpoint object and an observed point object on a second virtual viewpoint image on a two-dimensional image are changed in accordance with a distance between a second virtual viewpoint and an observed point, it is possible to easily recognize a sense of distance between a second virtual viewpoint and an observed point.

Heretofore, a plurality of exemplary embodiments of the present disclosure has been described in detail, but the present disclosure is not limited to the above-described exemplary embodiments. Various modifications can be made based on the gist of the present disclosure, and these modifications are not excluded from the scope of the present disclosure.

A computer program implementing a part or all of the control in the present exemplary embodiment, or the function of the above-described exemplary embodiments may be supplied to an image processing system via a network or various storage media. Then, a computer (or CPU or a micro processing unit (MPU)) in the image processing system may read out and execute the program. In this case, the program and a storage medium storing the program are included in the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-204963, filed Dec. 4, 2023, which is hereby incorporated by reference herein in its entirety.

What is claimed is:

1. A display controlling apparatus comprising:
one or more memories storing instructions; and
one or more processors executing the instructions to:
acquire information indicating a position of a first virtual viewpoint corresponding to a first virtual viewpoint image generated based on a plurality of captured images obtained by a plurality of imaging apparatuses, and information indicating a position of an observed point corresponding to the first virtual viewpoint; and
determine a size of an object indicating the observed point, based on a distance from the position of the first virtual viewpoint to the position of the observed point,
wherein the determining determines a size of an object indicating the observed point in a case where the distance from the position of the first virtual viewpoint to the position of the observed point is a second distance longer than a first distance, to be larger than a size of an object indicating the observed point in a case where the distance from the position of the first virtual viewpoint to the position of the observed point is the first distance, and
wherein control of displaying a second virtual viewpoint image corresponding to a second virtual viewpoint determined based on the first virtual viewpoint is performed, the second virtual viewpoint image including the object indicating the observed point that has a determined size, and an object indicating the first virtual viewpoint.

2. The display controlling apparatus according to claim 1, wherein a size of the object indicating the observed point is determined in such a manner as to be proportionate to the distance from the position of the first virtual viewpoint to the position of the observed point.

3. The display controlling apparatus according to claim 1, wherein, in a case where the distance from the position of the first virtual viewpoint to the position of the observed point is smaller than a threshold value, a size of the object indicating the observed point is determined to be a predetermined size, and in a case where the distance from the position of the first virtual viewpoint to the position of the observed point is equal to or larger than the threshold value, the size is determined to be a larger size as the distance becomes larger.

4. The display controlling apparatus according to claim 1, wherein the object indicating the first virtual viewpoint and the object indicating the observed point are three-dimensional models.

5. The display controlling apparatus according to claim 1, wherein a position of the second virtual viewpoint is a position at a predetermined distance from the position of the first virtual viewpoint.

6. A display controlling apparatus comprising:
one or more memories storing instructions; and
one or more processors executing the instructions to:
acquire information indicating a position of an observed point corresponding to a first virtual viewpoint corresponding to a virtual viewpoint image generated based on a plurality of captured images obtained by a plurality of imaging apparatuses; and
determine a size of an object indicating the observed point, based on a distance from a position of a second virtual viewpoint different from the first virtual viewpoint to the position of the observed point,
wherein the determining determines a size of an object indicating the observed point in a case where the distance from the position of the second virtual viewpoint to the position of the observed point is a second distance longer than a first distance, to be larger than a size of an object indicating the observed point in a case where the distance from the position of the second virtual viewpoint to the position of the observed point is the first distance, and
wherein control of displaying a second virtual viewpoint image corresponding to the second virtual viewpoint is performed, the second virtual viewpoint image including the object indicating the observed point that has a determined size.

7. The display controlling apparatus according to claim 6, wherein a size of the object indicating the observed point is a size on the second virtual viewpoint image.

8. A display controlling method comprising:
acquiring information indicating a position of a first virtual viewpoint corresponding to a first virtual viewpoint image generated based on a plurality of captured images obtained by a plurality of imaging apparatuses, and information indicating a position of an observed point corresponding to the first virtual viewpoint; and
determining a size of an object indicating the observed point, based on a distance from the position of the first virtual viewpoint to the position of the observed point,
wherein the determining determines a size of an object indicating the observed point in a case where the distance from the position of the first virtual viewpoint to the position of the observed point is a second distance longer than a first distance, to be larger than a size of an object indicating the observed point in a case where the distance from the position of the first virtual viewpoint to the position of the observed point is the first distance, and
wherein control of displaying a second virtual viewpoint image corresponding to a second virtual viewpoint determined based on the first virtual viewpoint is performed, the second virtual viewpoint image including the object indicating the observed point that has a determined size, and an object indicating the first virtual viewpoint.

9. A display controlling method comprising:
acquiring information indicating a position of an observed point corresponding to a first virtual viewpoint corresponding to a virtual viewpoint image generated based on a plurality of captured images obtained by a plurality of imaging apparatuses; and
determining a size of an object indicating the observed point, based on a distance from a position of a second virtual viewpoint different from the first virtual viewpoint to the position of the observed point,
wherein the determining determines a size of an object indicating the observed point in a case where the distance from the position of the second virtual viewpoint to the position of the observed point is a second distance longer than a first distance, to be larger than a size of an object indicating the observed point in a case where the distance from the position of the second virtual viewpoint to the position of the observed point is the first distance, and
wherein control of displaying a second virtual viewpoint image corresponding to the second virtual viewpoint is performed, the second virtual viewpoint image including the object indicating the observed point that has a determined size.

10. A non-transitory computer-readable storage medium that stores a computer program for causing a computer to:
acquire information indicating a position of a first virtual viewpoint corresponding to a first virtual viewpoint image generated based on a plurality of captured images obtained by a plurality of imaging apparatuses, and information indicating a position of an observed point corresponding to the first virtual viewpoint; and
determine a size of an object indicating the observed point, based on a distance from the position of the first virtual viewpoint to the position of the observed point,
wherein the determining determines a size of an object indicating the observed point in a case where the distance from the position of the first virtual viewpoint to the position of the observed point is a second distance longer than a first distance, to be larger than a size of an object indicating the observed point in a case where the distance from the position of the first virtual viewpoint to the position of the observed point is the first distance, and
wherein control of displaying a second virtual viewpoint image corresponding to a second virtual viewpoint determined based on the first virtual viewpoint is performed, the second virtual viewpoint image including the object indicating the observed point that has a determined size, and an object indicating the first virtual viewpoint.

11. A non-transitory computer-readable storage medium that stores a computer program for causing a computer to:
acquire information indicating a position of an observed point corresponding to a first virtual viewpoint corresponding to a virtual viewpoint image generated based on a plurality of captured images obtained by a plurality of imaging apparatuses; and
determine a size of an object indicating the observed point, based on a distance from a position of a second virtual viewpoint different from the first virtual viewpoint to the position of the observed point,
wherein the determining determines a size of an object indicating the observed point in a case where the distance from the position of the second virtual viewpoint to the position of the observed point is a second distance longer than a first distance, to be larger than a size of an object indicating the observed point in a case where the distance from the position of the second virtual viewpoint to the position of the observed point is the first distance, and
wherein control of displaying a second virtual viewpoint image corresponding to the second virtual viewpoint is performed, the second virtual viewpoint image including the object indicating the observed point that has a determined size.
